(19) United States
(12) Patent Application Publication
(10) Pub. No.: US 2026/0307906 A1
(43) Pub. Date: Oct. 8, 2026

(54) PICKING SYSTEM

(71) Applicant: Murata Machinery, Ltd., Kyoto-shi, Kyoto (JP)

(72) Inventor: Tatsuya NAKASONE, Kyoto-shi (JP)

(21) Appl. No.: 19/484,993

(22) PCT Filed: Mar. 28, 2024
(86) PCT No.: PCT/JP2024/012823

§ 371 Date: Nov. 17, 2025

(30) Foreign Application Priority Data
Jun. 20, 2023 (JP) 2023-100672

(51) Int. Cl. B65G 1/137; G06Q 10/087

(52) U.S. Cl. CPC B65G 1/1378; G06Q 10/08741; B65G 2201/0258; B65G 2209/08

(57) ABSTRACT

A picking system includes a first automated warehouse configured to store products on a case-by-case basis, a transfer station to transfer stock products from cases into totes, a second automated warehouse connected to the transfer station, a third automated warehouse connected to each of the transfer station and the second automated warehouse, a picking station connected to the third automated warehouse, and a controller configured or programmed to manage movement of the products, cause a first product with a high picking frequency to be moved directly from the transfer station to the third automated warehouse and stored therein, cause a second product with a low picking frequency to be moved from the transfer station to the second automated warehouse and stored therein, and, based on an order, cause the second product to be moved from the second automated warehouse to the third automated warehouse.

### BACKGROUND OF THE INVENTION

### 1. Field of the Invention

The present disclosure relates to picking systems.

### 2. Description of the Related Art

A system is known that includes a plurality of automated warehouses and conveys articles stored in the automated warehouses to a picking station. For example, in the system described in Japanese Unexamined Patent Application Publication No. 2018-47997, trays accommodating a plurality of articles are stored on storage racks of a first automated warehouse, and articles individually or collections of a plurality of articles are stored on storage racks of a second automated warehouse. Trays or articles retrieved from each of the first automated warehouse and the second automated warehouse are conveyed to a picking station near an automatic sorting device. At each picking station, an operator takes out necessary articles and transfers them to the automatic sorting device. The products sorted by the automatic sorting device are packed into boxes by an operator.

### SUMMARY OF THE INVENTION

As described above, systems including a plurality of automated warehouses have been considered in the related art, but there are many parts within the system where an operator's involvement is required. In recent years, there has been a trend toward diversification and an increase in the volume of orders. Therefore, in picking systems, there is a demand for an increase in the retrieval quantity to the picking station (the quantity of articles retrieved per unit of time).

Example embodiments of the present invention provide picking systems each capable of increasing a retrieval quantity at a picking station for a wide variety of orders.

A picking system according to an example embodiment of the present disclosure includes a first automated warehouse configured to store products on a case-by-case basis, a transfer station connected to the first automated warehouse and configured to transfer stock products from cases into totes, a second automated warehouse connected to the transfer station, a third automated warehouse connected to each of the transfer station and the second automated warehouse, a picking station connected to the third automated warehouse, and a controller configured or programmed to receive orders and manage movement of the products. The products include a first product having a high picking frequency and a second product having a picking frequency lower than the picking frequency of the first product. The controller is configured or programmed to cause the first product to be moved directly from the transfer station to the third automated warehouse and stored therein, cause the second product to be moved from the transfer station to the second automated warehouse and stored therein, and, based on an order, cause the second product to be moved from the second automated warehouse to the third automated warehouse, and cause the first product and the second product included in the order to be moved continuously from the third automated warehouse to the picking station.

According to a picking system of an example embodiment of the present invention, the controller is configured or programmed to combine a plurality of automated warehouses and manage the flow of products according to the picking frequency. The first product is moved directly from the transfer station to the third automated warehouse, whereas the second product is temporarily stored in the second automated warehouse and then moved to the third automated warehouse based on an order. This makes it possible to increase the shipment quantity to the picking station even for a large volume of orders including a wide variety of products.

In a picking system of an example embodiment of the present invention, the controller may be configured or programmed to, for example, recognize a shipment quantity of the second product included in the order and a storage quantity of the second product in the second automated warehouse. When the controller determines that the shipment quantity of the second product is large relative to the storage quantity, the controller may be configured or programmed to cause the second product stored on a case-by-case basis in the first automated warehouse to be moved to the transfer station, and then cause the second product, after being transferred into the totes, to be moved directly to the third automated warehouse. In this case, it is possible to respond to an urgent retrieval of the second product. For example, by moving the second product included in the order of the next batch directly from the transfer station, the time required to gather the second product in the third automated warehouse in the next batch can be shortened.

In a picking system of an example embodiment of the present invention, the controller may be configured or programmed to, for example, execute a plurality of batches sequentially and recognize an order included in a next batch scheduled after a current batch. In that case, during execution of the current batch, the controller may be configured or programmed to cause the first product not included in the next batch to be moved from the third automated warehouse to the second automated warehouse. In this case, even if it is the first product, it is moved to the second automated warehouse if it is not to be retrieved in the next batch. As a result, available space in the third automated warehouse can be increased, enhancing the margin for handling a wide variety of products. Stock optimization is achieved.

In a picking system of an example embodiment of the present invention, the third automated warehouse is, for example, an automated warehouse group including a plurality of automated warehouse units. The controller may be configured or programmed to, for example, execute a plurality of batches sequentially and recognize an order included in a next batch scheduled after a current batch. In that case, during execution of the current batch, the controller may be configured or programmed to cause the second product that is stored in the automated warehouse units and not included in the next batch to be moved from the third automated warehouse to the second automated warehouse. In this case, the second product is moved to the second automated warehouse if the second product is not to be retrieved from that automated warehouse unit in the next batch. As a result, available space in the third automated warehouse can be increased, enhancing the margin for handling a wide variety of products. Stock optimization is achieved.

In a picking system of an example embodiment of the present invention, the third automated warehouse is, for example, an automated warehouse group including a plurality of automated warehouse units. The controller may be configured or programmed to, for example, execute a plurality of batches sequentially and recognize an order included in a next batch scheduled after a current batch. In that case, during execution of the current batch, the controller may be configured or programmed to cause the second product that is stored in one of the automated warehouse units and is not to be retrieved in the next batch to be moved to another of the automated warehouse units from which the second product can be retrieved in the next batch. In this case, the second product is not retrieved from that automated warehouse unit in the next batch, but is moved, for example, to another automated warehouse unit closer to a scheduled picking station. The efficiency of movement from the automated warehouse group to the picking station is enhanced. Stock optimization is achieved.

According to example embodiments 41 the present disclosure, it is possible to increase the shipment quantity to the picking station even for a large volume of orders including a wide variety of products.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a block diagram showing an overall configuration of a picking system according to an example embodiment of the present disclosure.

FIG. 2 is a diagram showing an example of a flow of products (totes) in the picking system of FIG. 1.

### DETAILED DESCRIPTION OF THE EXAMPLE EMBODIMENTS

Hereinafter, example embodiments of the present disclosure will be described with reference to the drawings.

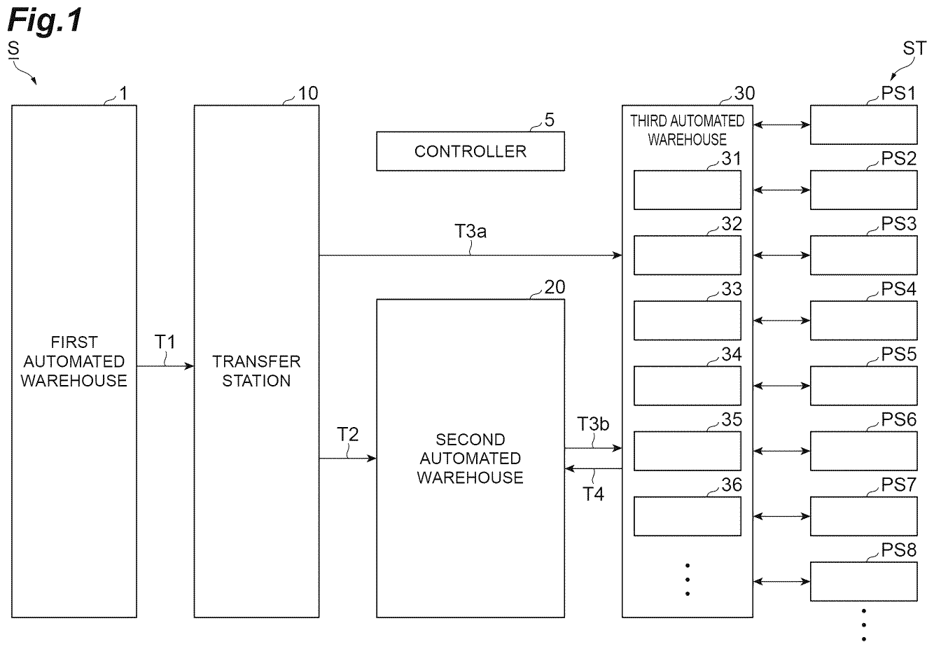

First, a picking system S according to an example embodiment will be described with reference to FIG. 1. The picking system S is a system installed, for example, in a distribution center or the like. The picking system S stores many types of products (articles) in a plurality of automated warehouses and moves products corresponding to orders from the plurality of automated warehouses to a picking station ST by sequentially executing a plurality of batches. In the picking system S, parts where operator's involvement is required between the plurality of automated warehouses are reduced, and movement control between the automated warehouses is performed by a controller 5. The picking system S is excellent in the retrieval quantity (the quantity of articles retrieved per unit of time) to the picking station ST for a wide variety of orders.

The picking system S includes a first automated warehouse 1, a transfer station 10, a second automated warehouse 20, a third automated warehouse 30, and a picking station ST. Each of the first automated warehouse 1, the transfer station 10, the second automated warehouse 20, and the third automated warehouse 30 may be provided, but a plurality of at least one of these may be provided as appropriate. The picking system S includes three different kinds (three types) of automated warehouses, including the first automated warehouse 1, the second automated warehouse 20, and the third automated warehouse 30.

The first automated warehouse 1 is connected to a receiving station of the center and stores many types of products on a case-by-case basis. When products are stored on a case-by-case basis, only one type of product is accommodated in one case. The case is also referred to as, for example, an outer box or an outer carton. The first automated warehouse 1 is a case automated warehouse. The first automated warehouse 1 is a stacker crane type automated warehouse and includes known components such as storage racks, a stacker crane, and conveyors related to retrieval and storage. The first automated warehouse 1 includes, for example, 30 to 40 aisles. In this specification, that a certain facility “connects” to another facility means that a configuration is provided that enables products (articles) to be moved (or conveyed) between those facilities.

The transfer station 10 is connected to the first automated warehouse 1 via a movement path T1. The transfer station 10 is a station to transfer stock products from cases into smaller totes. The transfer station 10 is a tote transfer station. The totes used at the transfer station 10 are, for example, foldable totes such as foldable containers, and are also referred to as returnable containers. In the picking system S, a large number of totes are used to move or convey many types of products, and are circulated and reused by moving along paths connecting the various automated warehouses and stations. The transfer station 10 includes, for example, about 25 to 35 individual i stations. At each of the individual stations, products are, for example, taken out from the cases and transferred into totes by an operator. Only one type of product is put into one tote. The transfer station 10 includes conveyors related to conveyance, a display device provided for an operator's work, a work space, and the like. Note that an automated transfer station including a plurality of tote transfer devices may be adopted as the transfer station 10.

The second automated warehouse 20 is connected to the transfer station 10 via a movement path T2. The second automated warehouse 20 is a double-deep type and shuttle type automated warehouse. The second automated warehouse 20 includes known components such as storage racks, a plurality of shuttle carts, and conveyors related to retrieval and storage. The second automated warehouse 20 has, for example, 20 to 30 aisles. In a double-deep type automated warehouse, two loads can be placed in the depth direction on each rack. A double-deep type automated warehouse has the advantage of a large storage quantity, although its retrieval capability is relatively inferior. In the picking system S, this type is adopted for mass storage of low-rank products, which will be described later.

The third automated warehouse 30 is connected to each of the transfer station 10 and the second automated warehouse 20 via movement paths T3a and T3b. The third automated warehouse 30 is, for example, an automated warehouse group including a plurality of automated warehouse units 31 to 36 . . . . Each automated warehouse unit has, for example, a shuttle type automated warehouse with four aisles. Each shuttle type automated warehouse includes storage racks and a shuttle cart that reciprocates on each level. In addition to the movement path T3b, a movement path T4 is separately provided between the second automated warehouse 20 and the third automated warehouse 30. The movement path T3b is a path to move products (totes) from the second automated warehouse 20 to the third automated warehouse 30, and the movement path T4 is a path to move products (totes) from the third automated warehouse 30 (any one of the automated warehouse units) to the second automated warehouse 20. The forward movement path T3b and the reverse movement path T4 may be shared.

The number of shuttle type automated warehouses that the third automated warehouse 30 has is set to, for example, a multiple of four. The third automated warehouse 30 as a whole has, for example, 24 to 36 aisles. One automated warehouse unit has a shuttle type automated warehouse with four aisles and is organized as one picking unit. Each picking unit is in charge of the picking operation for one small batch (a batch that is included in a large batch described later and is smaller than the large batch). For example, if the third automated warehouse 30 includes 24 aisles in total, six picking units (automated warehouse units 31 to 36) are included the third automated warehouse 30. If the third automated warehouse 30 includes 36 aisles in total, nine picking units are included in the third automated warehouse 30.

In the picking system S, each automated warehouse unit of the third automated warehouse 30 temporarily stores low-rank products that will be picked in a next batch scheduled after the currently executing batch, i.e., the current batch. The storage and movement control of products in the third automated warehouse 30 will be described later.

The picking station ST is connected to the third automated warehouse 30. Each aisle of the shuttle type automated warehouse is connected to the picking station ST via an individual path. The picking station ST including a plurality of order pick stations PS1 to PS8. The picking station ST has, for example, about 60 to 70 order pick stations. At each of the order pick stations, an operator, for example, picks products from the totes by the ordered quantity indicated in each order and packs them into boxes or the like. The picking station ST includes a display device provided for an operator's picking operation, a picking work space, conveyors, and the like.

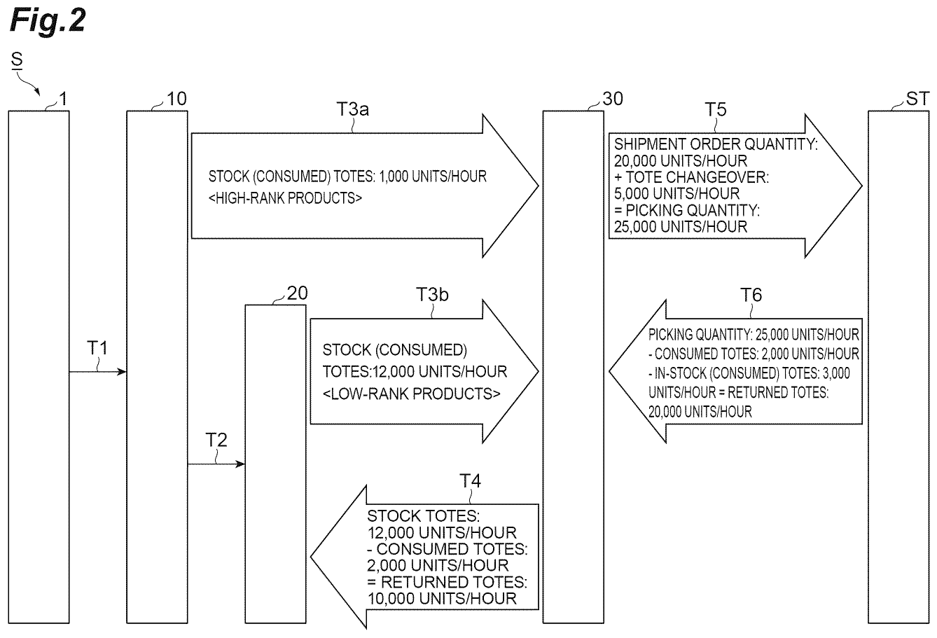

In the picking system S, the movement paths T1, T2, T3a, T3b, and T4 may include known conveying equipment including conveyors and/or conveying carts. The plurality of paths between the third automated warehouse 30 and the order pick stations of the picking station ST are represented collectively as movement paths T5 and T6 in FIG. 2. For the movement paths between the third automated warehouse 30 and each of the order pick stations, the forward movement path and the reverse movement path may also be shared.

The picking system S can be provided with other necessary components as appropriate, in addition to the configuration shown in FIG. 1. The picking system S may, for example, include a pallet automated warehouse connected to the first automated warehouse 1. A container sequencer may be provided between the picking station ST and a shipping station of the center. A case transfer path for shipping cases as a whole may be provided between the first automated warehouse 1 and the shipping station of the center.

The picking system S includes a controller 5 configured or programmed to receive orders from a host controller or the like and manage the movement of many types of products based on the received orders. The controller 5 is configured or programmed to execute various movement controls and other equipment controls in the picking system S. The controller 5 may include a processor such as a CPU, a RAM, and a ROM. The controller 5 is configured or programmed to perform information communication with each of the first automated warehouse 1, the transfer station 10, the second automated warehouse 20, the third automated warehouse 30, and the picking station ST, and transmit control signals to each of them. Although only one controller 5 is shown in FIG. 1, the functions of the controller 5 do not need to be integrated in one place (in one device). The various functions of the controller 5 may be distributed (shared) among individual controllers provided in each of the first automated warehouse 1, the transfer station 10, the second automated warehouse 20, the third automated warehouse 30, and the picking station ST. In that case, communication (transmission and reception) of information and commands between the controllers is necessary, but the construction of such a controller can be appropriately implemented by a person skilled in the art.

The controller 5 is configured or programmed to sequentially execute a plurality of large batches in the picking system S according to a predetermined schedule during a day. In the picking system S, many types of products are classified into high-rank products (first products) with a high picking frequency and low-rank products (second products) with a picking frequency lower than that of the high-rank products. To determine that a high-rank product has a “high picking frequency,” some index or threshold may be used, or the setting of high-rank products may be done manually by a user or an operator. Normally, the picking frequency of high-rank products is higher than the picking frequency of low-rank products. However, a situation may temporarily arise where the picking frequency of some low-rank products is higher than the picking frequency of some high-rank products. The classification and setting of high-rank and low-rank products can be done as appropriate, but overall, the picking frequency of high-rank products tends to be higher than the picking frequency of low-rank products.

Hereinafter, the product movement control by the controller 5 will be described in detail. The controller 5 is configured or programmed to store identification information for a certain type of product as to whether it is a high-rank product or a low-rank product. The controller 5 configured or programmed to identify whether each product is a high-rank product or a low-rank product for all products.

First, when a case containing products is received from the receiving station of the center, the controller 5 configured or programmed to cause the products to be moved to the first automated warehouse 1 and stored therein, regardless of whether the products are high-rank or low-rank. Next, the controller 5 moves the products to the transfer station 10. At the transfer station 10, the stock products in cases are transferred into totes. Next, the controller 5 causes the high-rank products to be moved directly from the transfer station 10 to the third automated warehouse 30 and stored therein. The controller 5 also causes the low-rank products to be moved from the transfer station 10 to the second automated warehouse 20 and stored therein. In the second automated warehouse 20, a storage capacity equivalent to about 1.5 to about 2 large batches, for example, is secured for low-rank products.

The controller 5 starts executing one large batch (current batch). The controller 5 first performs data acquisition and batch startup. The controller 5 then performs regular replenishment. The controller 5 moves the products included in the order of the next large batch (next batch) scheduled after the current large batch from the second automated warehouse 20 to the third automated warehouse 30. In particular, based on the order included in the next large batch, the controller 5 supplies the third automated warehouse 30 with the types and quantities of low-rank products corresponding to the shortfall relative to the required picking quantity. More specifically, the controller 5 aggregates the types and quantities of products to be shipped in the order included in the large batch, and supplies low-rank products to the third automated warehouse 30 so that each product meets or exceeds the shipment quantity. For high-rank products, they are stored in the third automated warehouse 30 with a determined replenishment point and replenishment quantity. For high-rank products, the controller 5 performs regular replenishment for the replenishment quantity when the stock falls below the replenishment point, and emergency replenishment for excessive allocation exceeding the storage quantity, from the first automated warehouse 1 via the transfer station 10.

Thereafter, the controller 5 continuously moves the high-rank products and low-rank products included in the order of the current large batch from the third automated warehouse 30 to the picking station ST. More specifically, for the high-rank products among the products included in the order, the controller 5 retrieves the products stored in the third automated warehouse 30. For the low-rank products, the controller 5 retrieves the products that have been moved from the second automated warehouse 20. At this time, each picking unit (shuttle cart) of the third automated warehouse 30 performs storage and retrieval. Thereafter, a picking operation is performed by an operator at each order pick station of the picking station ST.

The controller 5 configured or programmed to perform emergency replenishment (direct urgent retrieval) for low-rank products as needed. Specifically, the controller 5 recognizes the shipment quantity of a low-rank product included in an order and the storage quantity of the low-rank product in the second automated warehouse 20. Then, when the controller 5 determines that the shipment quantity of the low-rank product is large relative to the storage quantity, the controller 5 causes the low-rank product stored on a case-by-case basis in the first automated warehouse 1 to be moved to the transfer station 10, and then causes the low-rank product, after being transferred into the totes, to be moved directly to the third automated warehouse 30.

Here, a specific example of emergency replenishment of a low-rank product will be described. Product A, which is a low-rank product, is transferred from one case into two totes. In the replenishment point and replenishment quantity settings in the second automated warehouse 20, it is assumed that the replenishment point for product A is two totes, the replenishment quantity is three totes, and the storage quantity is three totes. The required quantity (shipment quantity) of product A in the third automated warehouse 30 is for seven totes, but the remaining quantity (storage quantity) from the previous batch is only one tote. In this case, the controller 5 supplies three totes from the second automated warehouse 20 to the third automated warehouse 30, but is still short by three totes. Therefore, the controller 5 causes two cases to be retrieved from the first automated warehouse 1, tote transfer is performed at the transfer station 10, and three totes are supplied to the third automated warehouse 30 as emergency replenishment. Note that the controller 5 supplies the remaining one tote to the second automated warehouse 20.

The storage quantity of product A in the second automated warehouse 20 becomes one tote, and since this is below the replenishment point in this case, the controller 5, as regular replenishment for the next large batch, causes one case to be retrieved from the first automated warehouse 1, tote transfer is performed at the transfer station 10, and two totes are supplied to the third automated warehouse 30. Although it is assumed here that the replenishment quantity in regular replenishment is two totes, if the product is transferred from one case into three totes, the controller 5 may cause three totes to be replenished in the minimum case unit.

In this way, the controller 5 configured or programmed to determine whether the supply of low-rank products can keep up based on the stock quantity in each automated warehouse at the completion of the previous large batch. Emergency replenishment takes about half the time required for the work of a small batch of each picking unit (automated warehouse unit) in the third automated warehouse 30. During emergency replenishment, picking of orders with no allocation for that product (product A above) is prioritized. Regular replenishment is performed sequentially in anticipation of the remaining picking quantity while carrying out the retrieval for each small batch.

As described above, in the current large batch, retrieval from the second automated warehouse 20, retrieval from the third automated warehouse 30, regular replenishment, and emergency replenishment are performed. The controller 5 is further configured or programmed to perform control to increase available space in the third automated warehouse 30 by utilizing the storage capacity of the second automated warehouse 20. The controller 5 is configured or programmed to execute this type of control for both high-rank products and low-rank products.

The controller 5 recognizes an order included in a next large batch scheduled after the current large batch. Then, during execution of the current batch, the controller 5 causes high-rank products not included in the next batch to be moved from the automated warehouse units 31 to 36. .. to the second automated warehouse 20. When it is determined that the high-rank product is needed in the next batch, the controller 5 causes the high-rank product to be moved (returned) to the third automated warehouse 30 and stored therein.

Alternatively, during execution of the current batch, the controller 5 causes low-rank products that are stored in the automated warehouse units 31 to 36 . . . and not included in the next batch to be moved from the third automated warehouse 30 to the second automated warehouse 20.

The flow of products in the picking system S where the above movement control is performed will be described with reference to FIG. 2. In FIG. 2, the flow of products is represented by the quantity of totes moved per hour. Note that the quantities shown here are merely an example. On the movement path T3a, bulk replenishment of high-rank products is performed (1,000 units/hour). Here, the minimum number of cases for pieces used in the picking units of the third automated warehouse 30 are transferred into totes and supplied to the third automated warehouse 30. On the movement path T3b, supply of low-rank products for picking is performed (12,000 units/hour). Here, stock containers of low-rank products are supplied to each picking unit on a batch basis. On the movement path T4, stock return to the storage stock is performed (10,000 units/hour). Here, stock containers for which there is no allocation in each picking unit in the next large batch are returned to the second automated warehouse 20 (the automated warehouse in the storage area). Note that for high-rank products, since the allocation probability is high, there is basically no need to return them. At the end of the day, high-rank products that are not scheduled for allocation in the first large batch of the next day may be returned to the second automated warehouse 20.

On the movement path T5, a quantity of totes corresponding to the number of picking operations moves to the picking station ST (25,000 units/hour). On the movement path T6, from that number of containers, a quantity of totes corresponding to the consumed container quantity moves to the third automated warehouse 30 (20,000 units/hour).

According to the picking system S of the present example embodiment described above, the controller 5 is configured or programmed to combine a plurality of automated warehouses and manage the flow of products according to the picking frequency. High-rank products (first products) are moved directly from the transfer station 10 to the third automated warehouse 30 via the movement path T3a, whereas low-rank products (second products) are temporarily stored in the second automated warehouse 20 and then moved to the third automated warehouse 30 via the movement path T3b based on an order. This makes it possible to increase the shipment quantity to the picking station ST even for a large volume of orders including a wide variety of products.

The controller 5 recognizes the shipment quantity of a low-rank product included in an order and the storage quantity of the low-rank product in the second automated warehouse 20, and when the controller 5 determines that the shipment quantity of the low-rank product is large relative to the storage quantity, the controller 5 causes the low-rank product stored on a case-by-case basis in the first automated warehouse 1 to be moved to the transfer station 10. More specifically, when the controller 5 determines that the absolute number of the shipment quantity of the low-rank product is larger than the absolute number of the storage quantity, the controller 5 causes the low-rank product stored in the first automated warehouse 1 to be moved to the transfer station 10. Alternatively, the controller 5 may be configured or programmed to cause the low-rank product stored in the first automated warehouse 1 to be moved to the transfer station 10 when the controller 5 determines that the ratio of the shipment quantity to the storage quantity of the low-rank product is large. Thereafter, the controller 5 causes the low-rank product, after being transferred into the totes, to be moved directly to the third automated warehouse 30 (emergency replenishment of low-rank products). This movement control between the automated warehouses makes it possible to respond to an urgent retrieval of low-rank products. For example, by moving the low-rank products included in the order of the next batch directly from the transfer station 10, the time required to gather the low-rank products in the third automated warehouse 30 in the next batch can be shortened.

During execution of the current batch, the controller 5 causes high-rank products not included in the next batch to be moved from the automated warehouse units 31 to 36 . . . to the second automated warehouse 20. With this movement control between the automated warehouses, even high-rank products are moved to the second automated warehouse 20 if they are not to be retrieved in the next batch. As a result, available space in the third automated warehouse 30 can be increased, enhancing the margin for handling a wide variety of products. Also, stock optimization is achieved.

During execution of the current batch, the controller 5 causes low-rank products that are stored in the automated warehouse units 31 to 36 . . . and are not included in the next batch to be moved from the third automated warehouse 30 to the second automated warehouse 20. With this movement control between the automated warehouses, low-rank products are moved to the second automated warehouse 20 if they are not to be retrieved from that automated warehouse unit in the next batch. As a result, available space in the third automated warehouse 30 can be increased, enhancing the margin for handling a wide variety of products. Stock optimization is achieved.

Although example embodiments of the present disclosure have been described above, the present invention is not limited to the above example embodiments. For example, during execution of the current batch, the controller 5 is configured or programmed to move a low-rank product that is stored in any of the automated warehouse units 31 to 36 . . . and is not to be retrieved in the next batch to another automated warehouse unit from which the low-rank product can be retrieved (or will be retrieved) in the next batch. With this movement control between the automated warehouse units within the third automated warehouse 30, the low-rank product is not retrieved from that automated warehouse unit in the next batch, but is moved, for example, to another automated warehouse unit closer to a scheduled picking station. For example, if a low-rank product stored in the automated warehouse unit 31 is not needed in the next batch, but is needed in the automated warehouse unit 32 in the next batch, the stock is moved to the automated warehouse unit 32 after picking in the automated warehouse unit 31 is completed. If the automated warehouse unit 33 also needs that low-rank product in the next batch, that low-rank product is retrieved from the second automated warehouse 20 and replenished to the automated warehouse unit 33. According to such replenishment control, the efficiency of movement from the automated warehouse group to the picking station is enhanced. Stock optimization is achieved.

In the above example embodiments, the controller 5 is configured or programmed to recognize the shipment quantity of a low-rank product included in an order and the storage quantity of the low-rank product in the second automated warehouse 20, and when the controller 5 determines that the shipment quantity of the low-rank product is large relative to the storage quantity, the controller 5 causes the low-rank product stored on a case-by-case basis in the first automated warehouse 1 to be moved to the transfer station 10. However, the controller 5 may be configured or programmed to recognize the shipment quantity of a low-rank product included in an order and the storage quantity of the low-rank product in the second automated warehouse 20, and when the controller 5 determines that the shipment quantity and the storage quantity of the low-rank product are substantially the same number (within a difference threshold of one to two units), the controller 5 may be configured or programmed to cause the low-rank product stored on a case-by-case basis in the first automated warehouse 1 to be moved to the transfer station 10. In this case, a countermeasure against errors in the stock quantity (storage quantity) is provided.

Example embodiments of the present disclosure may be applied to picking systems that do not operate by batches.

The first automated warehouse 1 may be a shuttle type automated warehouse. The second automated warehouse 20 is not limited to a double-deep type automated warehouse. The second automated warehouse 20 is also not limited to a shuttle type automated warehouse. The second automated warehouse 20 may be, for example, a stacker crane type automated warehouse. In each of the first automated warehouse 1 and the second automated warehouse 20, different types of automated warehouses may be combined.

While example embodiments of the present invention have been described above, it is to be understood that variations and modifications will be apparent to those skilled in the art without departing from the scope and spirit of the present invention. The scope of the present invention, therefore, is to be determined solely by the following claims.

1-5. (canceled)

6. A picking system comprising:
a first automated warehouse configured to store products on a case-by-case basis;
a transfer station connected to the first automated warehouse and configured to transfer stock products from cases into totes;
a second automated warehouse connected to the transfer station;
a third automated warehouse connected to each of the transfer station and the second automated warehouse;
a picking station connected to the third automated warehouse; and
a controller configured or programmed to receive orders and manage movement of the products; wherein
the products include a first product having a high picking frequency and a second product having a picking frequency lower than the picking frequency of the first product; and
the controller is configured or programmed to:
cause the first product to be moved directly from the transfer station to the third automated warehouse and stored therein;
cause the second product to be moved from the transfer station to the second automated warehouse and stored therein; and
based on an order, cause the second product to be moved from the second automated warehouse to the third automated warehouse, and cause the first product and the second product included in the order to be moved continuously from the third automated warehouse to the picking station.

7. The picking system according to claim 6, wherein the controller is further configured or programmed to:
recognize a shipment quantity of the second product included in the order and a storage quantity of the second product in the second automated warehouse; and
when it is determined that a shipment quantity of the second product is large relative to the storage quantity, cause the second product stored on a case-by-case basis in the first automated warehouse to be moved to the transfer station, and then cause the second product, after being transferred into the totes, to be moved directly to the third automated warehouse.

8. The picking system according to claim 6, wherein the controller is further configured or programmed to:
execute a plurality of batches sequentially and recognize an order included in a next batch scheduled after a current batch; and
during execution of the current batch, cause the first product not included in the next batch to be moved from the third automated warehouse to the second automated warehouse.

9. The picking system according to claim 6, wherein the third automated warehouse is an automated warehouse group including a plurality of automated warehouse units; and
the controller is further configured or programmed to:
execute a plurality of batches sequentially and recognize an order included in a next batch scheduled after a current batch; and
during execution of the current batch, cause the second product that is stored in the automated warehouse units and not included in the next batch to be moved from the third automated warehouse to the second automated warehouse.

10. The picking system according to claim 6, wherein
the third automated warehouse is an automated warehouse group including a plurality of automated warehouse units; and
the controller is further configured or programmed to:
execute a plurality of batches sequentially and recognize an order included in a next batch scheduled after a current batch; and
during execution of the current batch, cause the second product that is stored in one of the automated warehouse units and is not to be retrieved in the next batch to be moved to another of the automated warehouse units from which the second product can be retrieved in the next batch.
